(19) United States
(12) Patent Application Publication
(10) Pub. No.: US 2017/0154287 A1
(43) Pub. Date: Jun. 1, 2017

(54) WASTE MANAGEMENT SIMULATION SYSTEM AND METHOD

(71) Applicant: MANDALAY TECHNOLOGIES PTY LTD., South Brisbane, Queensland (AU)

(72) Inventors: Simon KALINOWSKI, Brisbane (AU); Darren PERRIN, Brisbane (AU)

(21) Appl. No.: 15/309,626

(22) PCT Filed: May 8, 2015
(86) PCT No.: PCT/AU2015/050224

§ 371 Date: Nov. 8, 2016

(30) Foreign Application Priority Data
May 8, 2014 (AU) 2014901700

(51) Int. Cl. G06Q 10/06; G06Q 10/00

(52) U.S. Cl. CPC G06Q 10/0639; G06Q 10/30

(57) ABSTRACT

A waste management simulation method and system is provided. The waste management simulation method includes: providing a graphical user interface for interactively defining a waste management model, wherein the model includes a plurality of waste inputs, a plurality of waste management facilities, and a plurality of waste streams connecting the waste inputs with the waste management facilities, and wherein the graphical user interface enables interactive definition of the waste streams; and determining at least one performance indicator of the model according to the defined waste management model and a forecast of the waste inputs.

### TECHNICAL FIELD

The present invention relates to waste management and in particular, although not exclusively to simulation of waste management systems.

### BACKGROUND ART

As populations grow, utilisation of waste management facilities, such as landfills and recycling stations, is generally increasing. Eventually, waste management facilities will reach a capacity, either in terms of processing capacity, or in terms of waste storage, as is generally the case for landfill sites.

The building of new waste management facilities is generally an expensive and slow process. As such, it is desirable to know as early as possible when new facilities will reach capacity and/or will be required to meet emerging processing requirements. Waste management analysis and waste strategy simulation can be used to determine future needs of a waste management system.

The calculation of performance of waste management facilities generally involves the collation and aggregation of multiple disparate data sources, rationalisation of data and data anomalies, access to industry standard figures to inform missing data points and complex formulae. Due to the complexity and time required to perform calculation of performance, individuals with specific skillset and experience (e.g. specialist consultants) are generally utilised to calculate performance.

Consultants are advisors to stakeholders who design, operate, introduce, manage or are impacted by these waste systems. They work across different projects, clients and sectors, often, as individuals, focusing on specific technical areas. This makes consultants, as a collective group, the leading source of information, knowledge and insight being best placed to influence best practice.

Generally stakeholders, such as local authorities and other waste operators, engage consultants on a point-in-time basis to provide strategic advice on changes to a waste system. This strategic advice may be used to support the introduction, removal, amendment or optimisation of components within the system. Engagements are often undertaken by Request for Tender processes, which can be time consuming and expensive. Furthermore, these engagements can involve significant data acquisition and cleansing activities due to the lack of consistent and current data sources.

Waste management analysis, waste strategy planning and strategic options assessment simulation can be used to determine future needs of a waste management system. Waste management systems are generally modelled using spreadsheets, where cells represent waste inputs, and complex formulae are used to model different aspects of the waste management system.

A problem with modelling waste management systems according to the prior art is that the process is time consuming, and complex. In particular, complexity is generally exponential with reference to the number of scenarios being simulated. As such, modelling is expensive and generally restricted to a limited set of scenarios.

Furthermore, the collation and aggregation of multiple disparate data sources, and rationalisation of data and data anomalies is also generally complex.

Additionally, due to the complex and generally highly proprietary nature of the models of the prior art, it is very difficult for consultants to engage their customer in population of the model or the development of scenarios, particularly in real time.

Yet further again, due to nature of the data generated in the model, and the very complex nature of the systems this data represents, current approaches (i.e. spreadsheets) are unable to efficiently represent the outcome of modelling, making it difficult to communicate these outcomes.

Accordingly, there is a need for an improved waste management simulation system.

It will be clearly understood that, if a prior art publication is referred to herein, this reference does not constitute an admission that the publication forms part of the common general knowledge in the art in Australia or in any other country.

### SUMMARY OF INVENTION

The present invention is directed to simulation of waste management systems, which may at least partially overcome at least one of the abovementioned disadvantages or provide the consumer with a useful or commercial choice.

With the foregoing in view, the present invention in one form, resides broadly in a waste management simulation method including:

providing a graphical user interface for interactively defining a waste management model, wherein the model includes a plurality of waste inputs, a plurality of waste management facilities, and a plurality of waste streams connecting the waste inputs with the waste management facilities, and wherein the graphical user interface enables interactive definition of the waste streams; and

determining at least one performance indicator of the model according to the defined waste management model and a forecast of the waste inputs.

Advantageously, embodiments of the present invention enables modelling of waste management system in a simple and efficient manner. For example, by interactively defining waste streams in a graphical user interface, the time taken to define a waste management model can be greatly reduced. Similarly, alternative scenarios can be efficiently modelled and evaluated by interactively redefining waste streams, for example modelling the diversion of waste from one waste management facility to another.

The method can further include defining a plurality of waste containers, wherein the waste inputs are defined at least partly according to the waste containers. The waste containers can, for example, include a ‘general waste’ waste container, a ‘green waste’ waste container and ‘recycling’ waste container. According to certain embodiments, the waste containers are dynamically defined.

The method can further include defining a composition of each of the waste containers, wherein the waste inputs are defined at least partly according to the composition of each of the waste containers.

The forecast of the waste inputs can be defined according to a population growth. Furthermore, exceptional increases in waste input can be provided, wherein the forecast is adjusted according to the exceptional increases in waste input. Such exceptional increases can be due to, for example, floods, storms and the like.

The waste management facilities can include recycling facilities and landfill facilities. The skilled addressee will readily appreciate that a variety of other waste treatment facilities which closely model the performance of real world waste management practices can be included, including Mechanical, Biological, Heat and Waste to Energy waste treatment facilities.

According to certain embodiments, the graphical user interface enables a user to define waste stream between a waste input and a waste management facility by dragging an identifier of the waste input to an identifier of the waste management facility.

Advantageously, dragging and dropping an identifier of a waste input to an identifier of the waste management facility is a fast and efficient means of defining a waste stream (and thus in turn a waste management model), in clear contrast to manually editing data in a spreadsheet as is known in the prior art.

The identifiers of the waste input and the waste management facility can comprise images representing the waste input and the waste management facility.

According to certain embodiments, the method further includes:

determining the at least one performance indicator at a plurality of points on a timeline; and

presenting the at least one performance indicator according to the timeline.

Presenting the at least one performance indicator according to the timeline can comprise automatically presenting changes to the at least one performance indicator according to a simulated playback of the timeline.

The at least one performance indicator can comprise a target. Furthermore, completion of the target can be visualised. For example, visualisation of completion of the target can comprise a tick or cross, or a colour coding associated with the target. Similarly, a user can place a target across a timeline and compare calculated performance indicator to target.

According to certain embodiments, the method further comprises providing an alert when a criterion is met. The criterion can correspond to a potential issue, such as overcapacity of a facility or the like. The alert can be a visual alert.

According to certain embodiments, the GUI further enables waste streams to connect waste management facilities with other waste management facilities. As such, a waste management facility is able to initially process the waste, followed by a second waste management facility.

According to other embodiments, the GUI further enables a user to select a first portion of an output to be sent to a first waste management facility, and a second portion of the output to be sent to a second waste management facility. For example, waste management facilities can share a particular type of waste (e.g. 50% waste sent to each waste management facility), or process different types of waste (e.g. all glass can be sent to a first facility, and all metal to a second facility).

The GUI may further enable a user to select an output of a first waste management facility, or a portion thereof, to be sent to a second waste management facility.

The method may further include modelling of alternate scenarios for waste projects, to assess impact on changes in behaviour.

The method may further include modelling of alternate collection systems schemes and services to assess impact on waste generation behaviours and service costs.

The method may include modelling of alternate processing and disposal configuration that allows assessment of investment strategy and environmental performance

According to certain embodiments, the method may enable the creation of a consolidated scenario that allows for the combination of different options, to test sensitivity and investigate a significant number of different solution sets, providing for great scope of service delivery and improved strategic outcomes.

Waste management facility performance can be configured using detailed and non-detailed approaches. Non-detailed approaches can use Monte-Carlo algorithms to determine current facility performance based upon system-defined or user defined criteria to solve for observed current facility performance. Detailed approach comprises defining details of facility performance.

In another form, the present invention resides broadly in a waste management simulation system including:

a processor, and

a memory coupled to the processor, the memory including instruction code executable by the processor for:
providing a graphical user interface for interactively defining a waste management model, wherein the model includes a plurality of waste inputs, a plurality of waste management facilities, and a plurality of waste streams connecting the waste inputs with the waste management facilities, and wherein the graphical user interface enables interactive definition of the waste streams; and

determining at least one performance indicator of the model according to the defined waste management model and a forecast of the waste inputs.

The system may include a server including the processor and memory.

The system may include a data interface, for providing the graphical user interface to a user device by a communications network.

Embodiments of the present invention advantageously support the publishing of models and scenarios and models for the purpose of consultancy delivery or community engagement.

A collaboration framework may be defined to support different types of sharing paradigms from printed report to fully interactive model, in order to allow the exchange of data and short the strategy cycles.

Embodiments of the invention define a standard data framework that represents common practice and advantageously provides opportunity to improve currency of data and resolve current data quality and exchange issues thru a open data exchange layer.

Embodiments of the invention include a marketplace that allows stakeholders to submit models and or scenarios for review under a different engagement model to existing waste strategy engagements, support the creation of an advisory services framework.

Embodiments of the present invention support improved waste management analysis; waste strategy planning and strategic options assessment processes thru improved modelling and simulation of waste management systems and scenarios analysis.

Embodiments of the present invention various advantages, including provide flexibility in modelling of the waste generation inputs for a local area, by one or more of the following:

A) Providing direct and live interfaces to authoritative sources of geographical profile data including, but not limited to, population, household and economic data, that is used in development of waste projections,

B) Providing a graphical interface for the creation of a local waste profile that enables the creation of current and historical waste services;

C) Providing a graphical interface for simple and efficient mapping of waste services according to a set of industry standard and globally accepted waste pools and stream, which significantly reduces the time and complexity of generating accurate historical waste data;

D) providing default waste stream composition data, which in turn provides customers without accurate audit data access to industry standard global benchmark that improves their ability to accurately model the system;

E) enabling calculation and presentation of waste generation benchmarks, analytics and infographics based on a set of industry KPIs including comparative performance analysis across local profile, jurisdiction and nation;

F) providing the ability to use default data as a baseline or build a custom local and waste profile to use as the baseline using forecasts;

G) providing the ability to use custom demographic projections for population, household and other local profile indicators;

H) providing the ability to use a custom waste projection for a waste stream;

I) providing the ability to select multiple different custom waste projections to create a new baseline waste profile;

J) Reducing the complexity of modelling changes to projected waste inputs through a series of simple and innovative local area and waste projection methods including:
1) Providing a graphical interface for the generation of local profile scenarios based on different projection measure and techniques, and the ability to combine multiple local projections for the creation of demographic and economic profile for a single geographic location;
2) Providing a graphical interface for the generation of waste projections based on different projection measures and techniques, and the ability to combine the multiple waste projections for different waste streams into a single waste forecast;
3) Providing the ability to project the additional future waste streams, which provides the user with the ability to reflect significant cyclical or one-off changes in waste inputs such floods and storms or major events like the Olympics;

K) Providing flexibility through a graphical interface that supports for the interactive modelling of a waste system wherein the model provides the user with the capacity to configure the scope and granularity of the system, including the ability to connect a plurality of waste pools and streams to a plurality of waste management facilities, either directly or via a plurality of waste collection services and schemes.

L) Providing a visually innovative means of representing a collection system through a graphical user interface. The flexibility and configurability of the inventions provides users with the ability to model at any level of flexibility or abstractions and supports:
1) Simple wizard based interface allows users to quickly and simply generation of one or more schemes against a Waste stream to represent the clients segmentation of their subscriber audience;
2) An ability to accurate model the allocation of waste from a stream to a scheme and determine the subsequent composition of the scheme allows the creation of meaningful comparative analytics around waste generation behaviours
3) An ability to define a plurality of waste containers, wherein the waste inputs are defined at least partly according to the waste containers, but can be aggregated to provide insight to service type and delivery metrics;
4) support robust modelling of waste behaviours, including waste container composition, set out rates, participation rates and recognition rates, including ability to access international standards for composition data; and
5) determines the performance of the different components of the system against a predefined set of industry accepted KPIs.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Various embodiments of the invention will be described with reference to the following drawings, in which:

FIG. 1 illustrates a waste management simulation system, according to an embodiment of the present invention;

FIG. 2 illustrates a screenshot of a scheme selection screen of the system of FIG. 1, according to an embodiment of the present invention;

FIG. 3 illustrates a screenshot of an edit scheme screen of the system of FIG. 1, according to an embodiment of the present invention;

FIG. 4 illustrates a screenshot of a waste volume input screen of the system of FIG. 1, according to an embodiment of the present invention;

FIG. 5 illustrates a screenshot of a baseline waste forecasting screen of the system of FIG. 1, according to an embodiment of the present invention;

FIG. 6 illustrates a screenshot of a baseline mass flow screen of the system of FIG. 1, according to an embodiment of the present invention;

FIG. 7 illustrates a screenshot of an output configuration screen of the system of FIG. 1, according to an embodiment of the present invention;

FIG. 8 illustrates a screenshot of a subscriber migration screen of the system of FIG. 1, according to an embodiment of the present invention;

FIG. 9 illustrates a screenshot of a recognition rate target screen of the system of FIG. 1, according to an embodiment of the present invention; and

FIG. 10 illustrates a method of waste management simulation, according to an embodiment of the present invention.

Preferred features, embodiments and variations of the invention may be discerned from the following Description of Embodiments which provides sufficient information for those skilled in the art to perform the invention. The Description of Embodiments is not to be regarded as limiting the scope of the preceding Summary of the Invention in any way.

### DESCRIPTION OF EMBODIMENTS

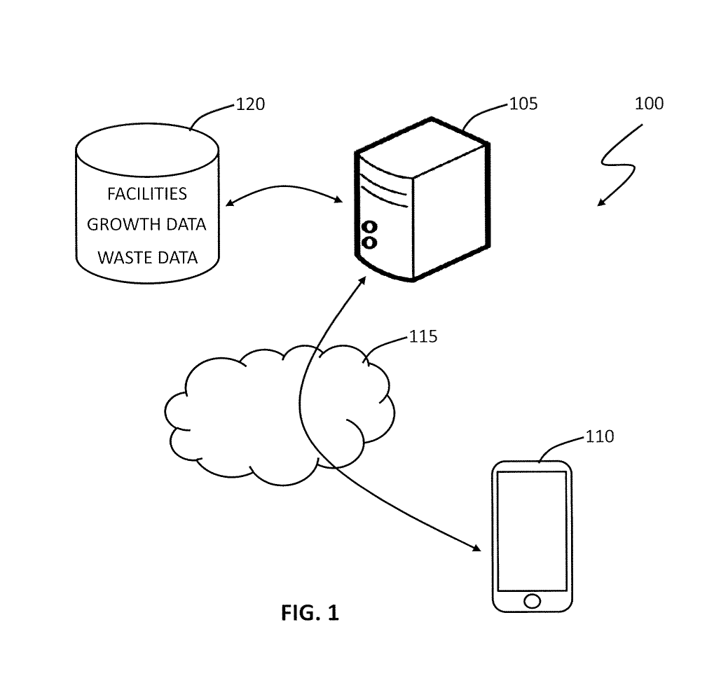

FIG. 1 illustrates a waste management simulation system 100, according to an embodiment of the present invention.

The waste management simulation system 100 includes a server 105, for providing a graphical user interface (GUI) to a user device 110, by a communications network 115, such as the Internet.

The server 105 is coupled to one or more data stores 120, which include waste input data, waste management facility data, and growth data. The skilled addressee will, however, appreciate that the waste input data, waste management facility data, and growth data can be provided by a user on demand, or determined at least partly according to parameters provided by the user.

The GUI, described in further detail below, enables a user to interactively define a waste management model. The waste management model includes a plurality of waste inputs, defined according to the waste input data, and a plurality of waste management facilities, defined according to the waste management facility data. The GUI enables the user to define a plurality of waste streams connecting the waste inputs with the waste management facilities. The waste streams define a flow of waste from the waste inputs to the waste management facilities.

Once the waste management model is defined, the server 105 determines at least one performance indicator of the model according to the defined waste management model and a forecast of the waste inputs, defined according to the growth data.

The at least one performance indicator can, for example, comprise a collection recycling rate, an actual recycling rate, a landfill diversion rate, a recovery rate, a quantity of waste to landfill, a quantity of waste that is recycled, or a quantity of waste that is recovered.

According to certain embodiments, the growth data includes population and household figures, for example from the Australian Bureau of Statistics. The population and household figures can, however, be overridden if needed, for example to enable modelling of exceptional growth rates or the like.

The GUI further enables the user to modify the waste management model and redetermine the at least one performance indicator of the model according to the redefined waste management model and the forecast of the waste inputs. Similarly, the GUI enables the user to modify the forecast, for example by entering an exceptional increase in waste input due to floods, storms and the like.

As such, the waste management simulation system 100 enables a user to quickly and efficiently model several different scenarios, including the addition of a new waste management facility, the decommissioning of an existing waste management facility, or a sudden increase in waste input. This in turn enables a user to get a broader understanding of the waste management system, and potential weak points in the system.

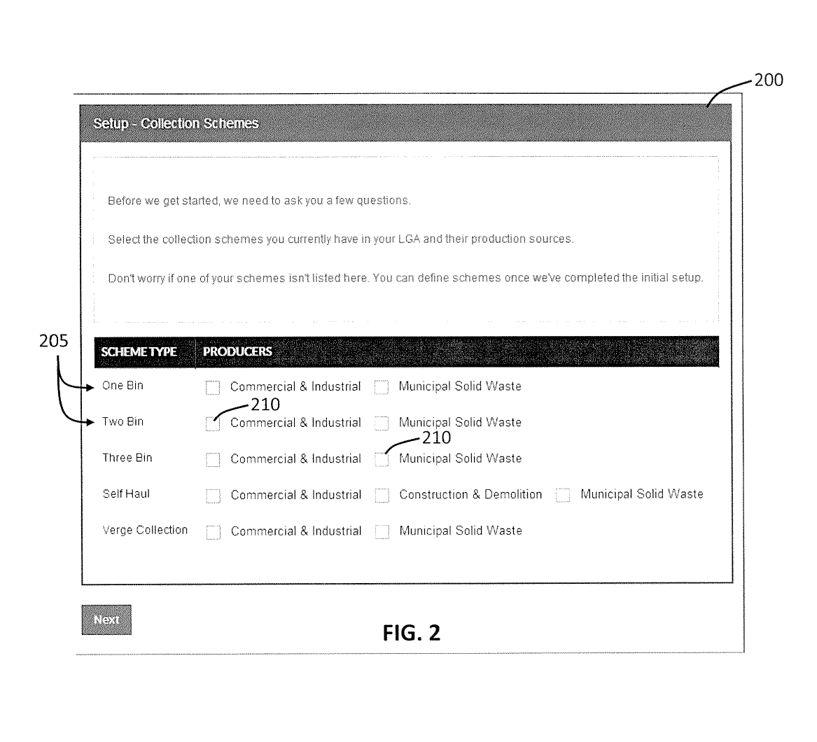

FIG. 2 illustrates a screenshot 200 of a scheme selection screen of the system 100, according to an embodiment of the present invention. The collection schemes can include a one bin scheme, where all waste is placed in a single bin, a two bin scheme, where general waste and recycling bins are provided, or any other suitable waste collection scheme type. The schemes determine a volume of waste and a composition of that waste.

The schemes selection screen includes a plurality of scheme type rows 205, each scheme type row 205 including a plurality of producer checkboxes 210. The producer checkboxes 210 correspond to different producers of waste to which the scheme can apply, and enable a user to define what services are offered to which producers.

As an illustrative example, in the case of a city council, the waste produced by residents may be referred to as municipal solid waste, to which various means of collecting (or discarding) the municipal solid waste can be provided.

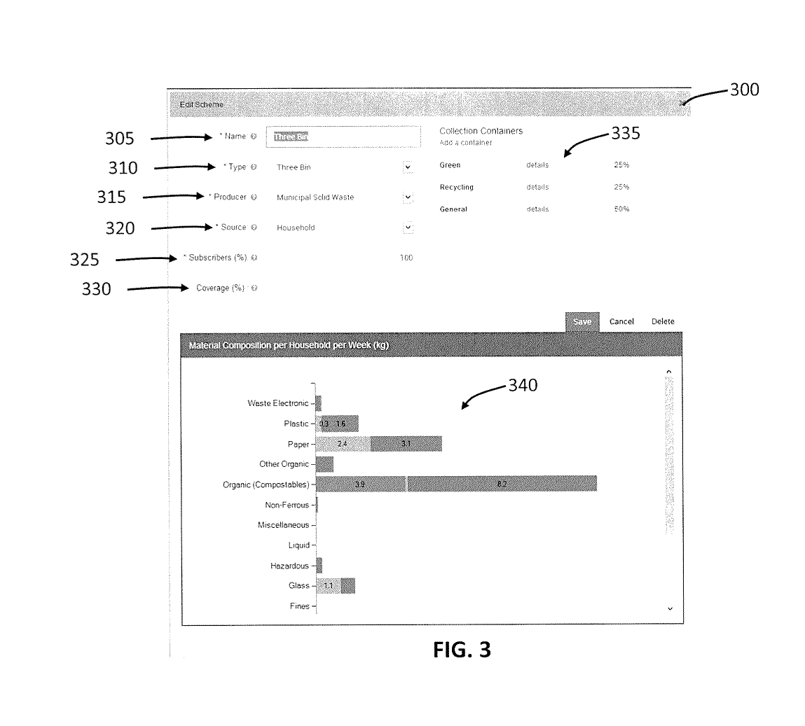

FIG. 3 illustrates a screenshot 300 of an edit scheme screen of the system 100, according to an embodiment of the present invention.

The edit scheme screen includes a scheme name field 305, for specifying a name of the scheme, a type drop down menu 310, for specifying a type of scheme, a producer drop down menu 315, for specifying a producer of the waste, and a source drop down menu 320, to indicate a source of the waste. The edit scheme screen further includes a subscribers field 325, for inputting a percentage of subscribers to which the scheme relates, and a coverage input field 330, for inputting a coverage percent of the scheme.

The edit scheme screen includes a containers definition section 335, which defines containers that are associated with the scheme. The containers can include, for example, a ‘green waste’ container, a ‘recycling’ container and a ‘general waste’ container. The containers definition section 335 enables a user to define containers that are associated with the scheme by adding containers, and providing details of collections rates of the respective containers. In particular, it can, for example, be specified that green and recycling containers are collected half as often as general waste containers.

Finally, the edit scheme screen includes a material composition graph 340, identifying a composition of waste material in the respective containers. The material composition graph 340 can be presented as a weight per household per week, as a percentage of total waste, or using any other suitable measure. The material composition graph 340 provides a break-down of material that is arriving in the various containers or schemes, and the various containers can be colour coded, hatched, or differentiated by any other suitable means.

The material composition graph 340 enables a user to see, for example, that about half of all paper is being collected in general waste bins and is thus not being recycled. As such, users are able to choose to implement different programs to ensure that waste producers, e.g. households, are made aware of recycling opportunities and requirements.

The data used to generate the material composition graph 340 can be determined based upon earlier waste audits, or any other suitable data.

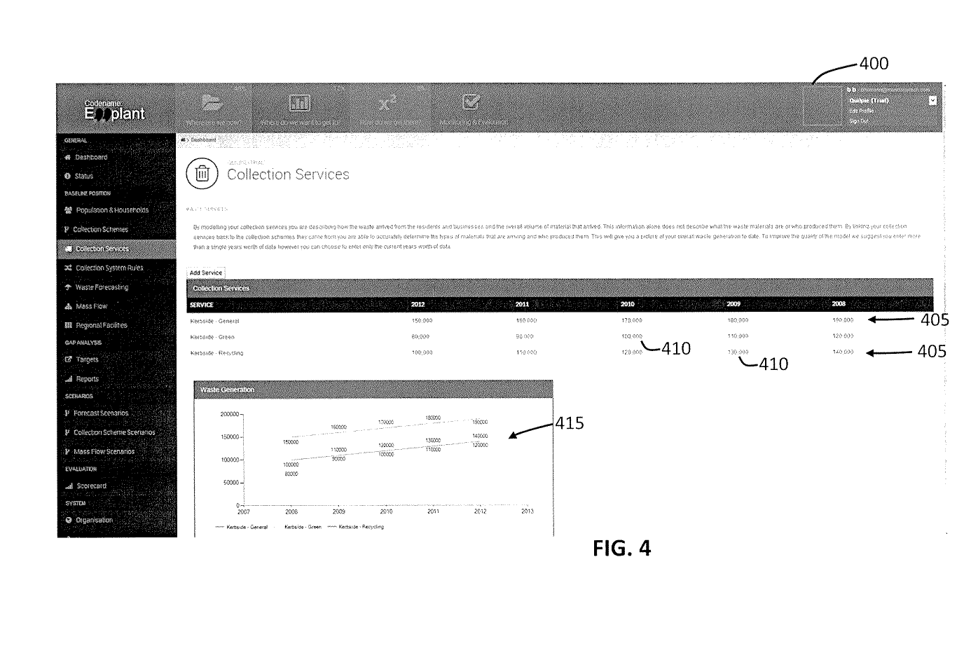

FIG. 4 illustrates a screenshot 400 of a waste volume input screen of the system 100, according to an embodiment of the present invention.

The waste volume input screen includes a plurality of service rows 405, each service row 405 associated with a collection scheme described earlier.

Each of the plurality of service rows 405 includes a plurality of data points 410, the data points 410 illustrating a total volume of waste associated with the collection scheme for a corresponding time period. For example, each data point 410 can be associated with a calendar year or financial year.

As such, a user is able to enter details of the volume of waste produced in relation to each of the collection schemes, for a number of years, by entering values into the data points 410.

The waste volume input screen further includes a waste generation chart 415, which maps the total volume of waste of the data entry points 410 against a timeline. The different collections schemes can be plotted using different colours, line styles, or differentiated in any suitable manner. The waste generation chart 415 enables a user to quickly and efficiently visualise the volume of waste over time with respect to each of the collection schemes, which in turn enables visualisation of trends in waste production.

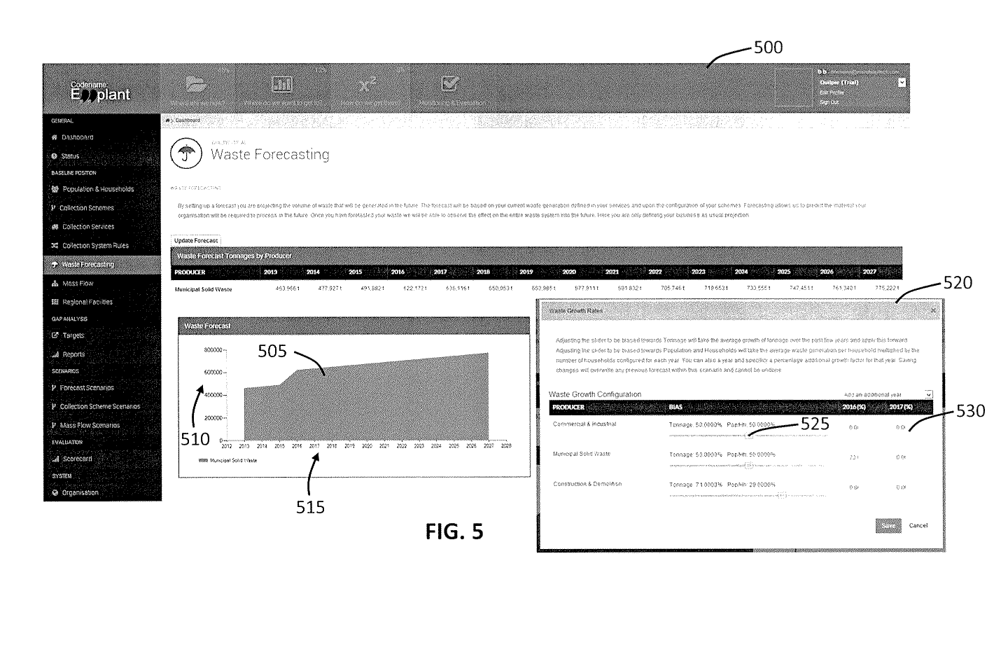

FIG. 5 illustrates a screenshot 500 of a baseline waste forecasting screen of the system 100, according to an embodiment of the present invention.

The waste forecasting screen includes a waste forecast graph 505, including a waste forecast amount on a first axis 510 and a timeline on a second axis 515. The timeline can include one or more previous years, and generally includes several years in the future to enable suitable waste forecasting.

The baseline waste forecasting screen further includes a waste growth adjustment window 520, which enables the user to adjust growth factors for various producers. In particular, the waste growth adjustment window 520 includes a plurality of waste biasing sliding bars 525, enabling the user to adjust a bias between household and population growth, and tonnage growth for various types of waste. As such, the user is able to vary the impact of tonnage growth, e.g. average growth in tonnage, with an impact of household and population growth.

Biasing towards tonnage for commercial operations is common, as industrial waste is more dependent on a previous history than on a population growth. Municipal waste, on the other hand, is heavily dependent on population growth, and as such, biasing towards population growth for municipal waste is common.

Furthermore, the waste growth adjustment window 520 includes a plurality of additional growth entry fields 530, for specifying an additional growth rate of a producer for a particular time period. The additional growth rate can be used to specify an increase above current trends, such as a sudden increase due to a weather event, such as a flood.

Upon entry of data in the waste growth adjustment window 520 (or modification of data therein), the waste forecast graph 505 is modified according to the new data. As such, a user is able to see consequences of the changes of growth on solid waste production in real time.

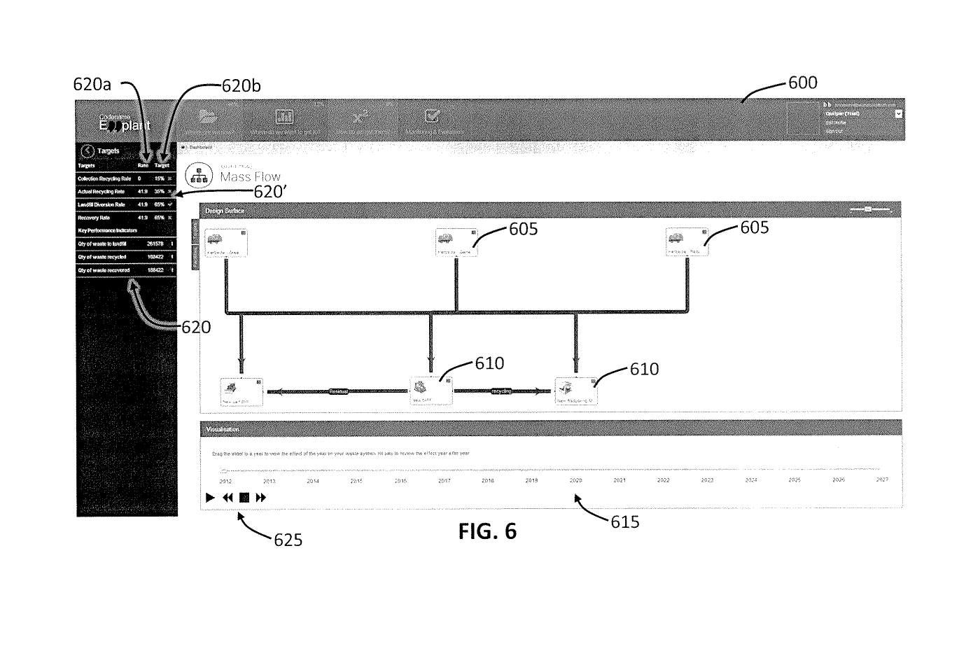

FIG. 6 illustrates a screenshot 600 of a baseline mass flow screen of the system 100, according to an embodiment of the present invention. The baseline mass flow screen enables a user to add waste processing facilities and plumb together waste flows from services to the facilities and between facilities, to define a waste management model.

The baseline mass flow screen includes a plurality of waste services 605, corresponding to the waste services defined earlier, and a plurality of facilities 610. The facilities 610 are entered by the user, and can be introduced at a particular time on a timeline. Similarly, facilities 610 can be decommissioned at a particular time on the timeline.

The waste services 605 and facilities 610 can be connected dynamically by “dragging” connections from the waste services 605 to the facilities 610, and by dragging connections from one facility 610 to another facility 610. As such, the user can quickly specify, for example, that all kerbside recycled waste is to be sent to a particular processing facility, and that all general waste is to be sent to a particular landfill.

As discussed in further detail below, in addition to dragging connections, outputs of waste services 605 and facilities 610 can be specified according to an output configuration screen. The editing of outputs enables certain types of outputs to be sent to one facility, and other types of outputs to be sent to another facility.

The baseline mass flow screen further includes a timeline 615, and a target evaluation section 620. In particular, the target evaluation section 620 includes a plurality of targets 620′, each target including with an estimated rate 620a and a target value 620b. The estimated rate is determined according to a position on the timeline, the waste management model, and the forecasting of the waste inputs.

The timeline 615 is associated with timeline navigation elements 625, which includes a play, stop, forward and reverse navigation element. As such, the user is able to view performance indicators with respect to targets, over period time.

According to certain embodiments, the targets 620′ include a graphical identifier representing whether the estimated rate 620a is within the target value 620b. As an illustrative example, the target 620′ can include a tick symbol to indicate that the estimated rate 620a is within the target value 620b, or a cross symbol to indicate that the estimated rate 620a is not within the target value 620b. Alternatively or additionally, colour coding can be used to indicate that the estimated rate 620a is within the target value 620b.

The user can use the timeline 615 and the targets 620′ to evaluate the waste management model over a period of time. In particular, the user can determine that targets will no longer be met at a certain point in time, and may choose to modify the model at that point.

According to certain embodiments, reports can be automatically generated for the waste management model. Examples of reports include key performance indicators (KPIs) over a year or several years, landfill or recycle tonnages, or tonnage generated by producer and service or producer and scheme.

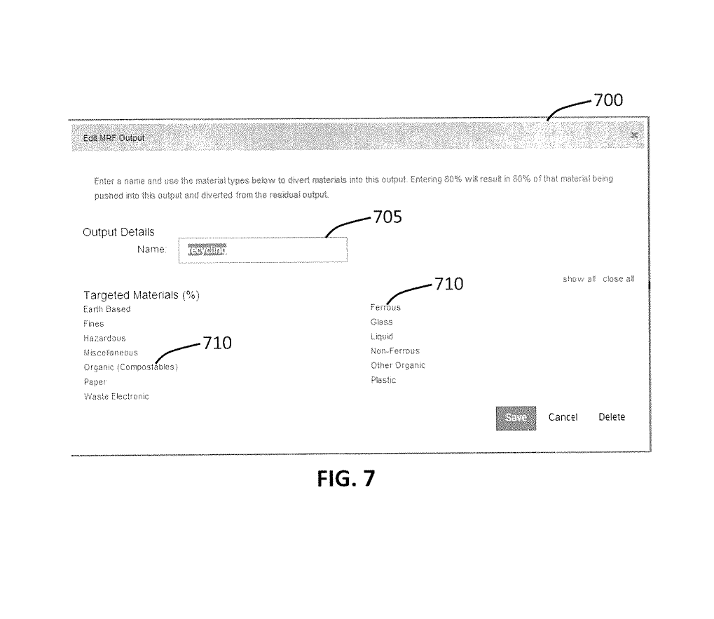

FIG. 7 illustrates a screenshot 700 of an output configuration screen of the system 100, according to an embodiment of the present invention.

The output configuration screen enables a user to configure outputs of, for example, facilities, as discussed above. As such, the performance of each facility can be customised to meet performance requirements of the system.

The output configuration screen includes an output name entry field 705, for entering a name of the output, and a plurality of target materials selection elements 710. Upon selection of a target materials selection element 710, the user is able to specify a percentage of the target material that is to be diverted to the output which is being edited.

Examples of target materials include earth based materials, fines, hazardous materials, and the like. However the skilled addressee will readily appreciate the several target materials can be aggregated into a single output.

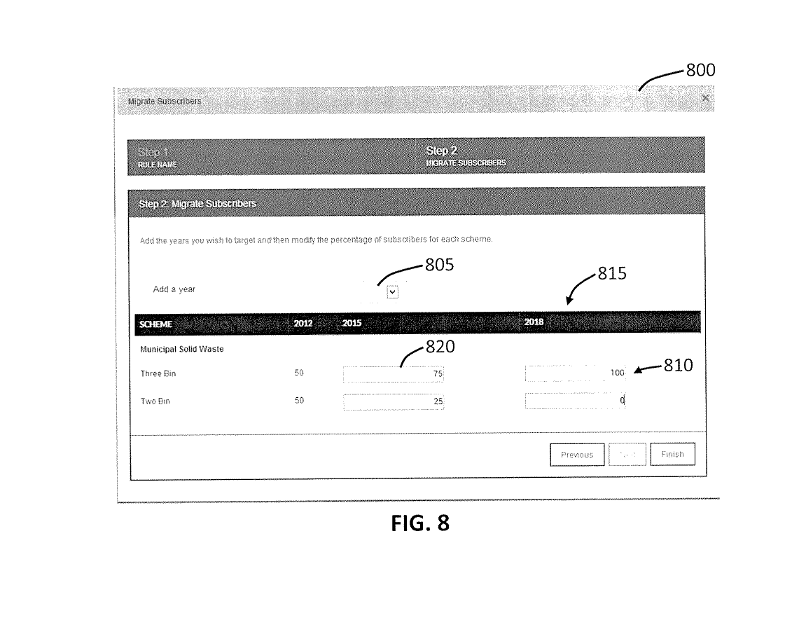

FIG. 8 illustrates a screenshot 800 of a subscriber migration screen of the system 100, according to an embodiment of the present invention. The subscriber migration screen enables a user to model the effect of migrating certain subscribers from one scheme to another.

The subscriber migrations screen includes a target year selection menu 805, which enables the user to select a year in which to target migration. The subscriber migrations screen further includes a plurality of scheme rows 810, and a plurality of year columns 815, the year columns corresponding to years selected for target migration.

According to certain embodiments, the plurality of year columns 815 includes a column for a most recent year in which data is available, e.g. a current or previous year. As such, the user is able to use data of the most recent year as a baseline from which to select target rates.

Each scheme row 810 year column 815 combination includes a target rate entry field 820, for enabling a user to enter a target rate associated with the corresponding scheme and year. As such, the user is able to enter target rates for several years, and thus control the rate in which users are migrated.

The subscriber migrations screen enables a user to model shifting users away from poor performing services onto better performing services, and thus identifying the overall improvement. As an illustrative example, the subscriber migrations screen can be used to model giving users a recycling bin where previously they did not have one.

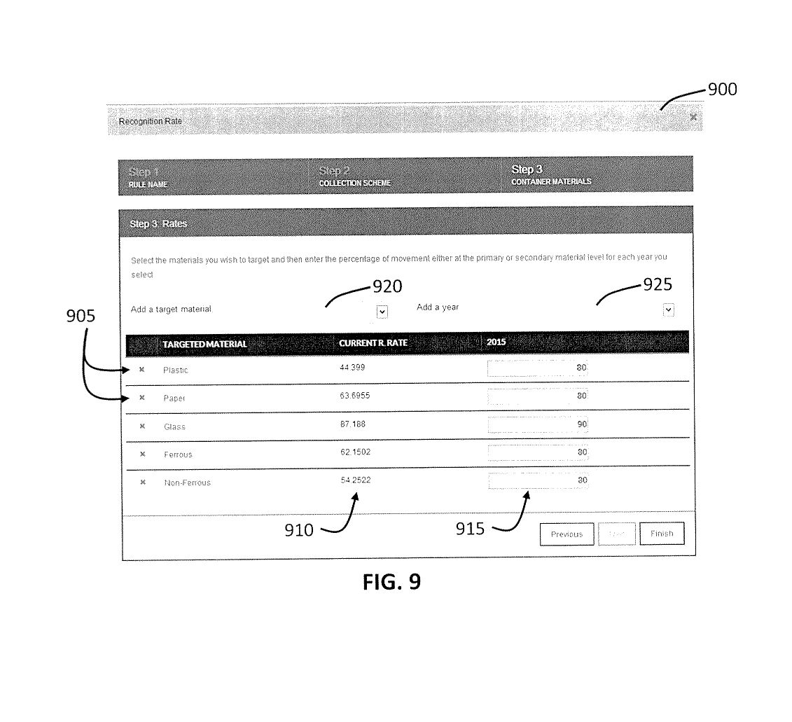

FIG. 9 illustrates a screenshot 900 of a recognition rate target screen of the system 100, according to an embodiment of the present invention.

The recognition rate target screen enables a user to enter a recognition rate of a particular target material for a collection scheme for a particular year. As an illustrative example, 64% of paper may be currently recycled (i.e. collected using a recycling scheme). A user may model an impact of increased recycling, e.g. an 80% recognition rate for paper, and thus choose to implement an educational scheme accordingly.

The recognition rate target screen includes a plurality of target material rows 905, each target material row 905 including a current rate entry 910 and a target rate entry field 915. The user is able to enter a target rate in the target rate entry field and thus model the impact of achieving that target rate.

The recognition rate target screen includes an add material menu 920, which enables the user to add further materials to the recognition rate target screen, and a year selection menu 925, which enables the user to add a year to which the targets are to apply. Selection of a further material results in further rows 905, and selection of years results in target rate entry fields for the selected year.

By educating users about what materials can be placed in what recycling bins a user can improve the recognition rate. As such, when a bottleneck is identified in the system, educating users to more efficiently utilise the system may be an alternative to introducing new facilities.

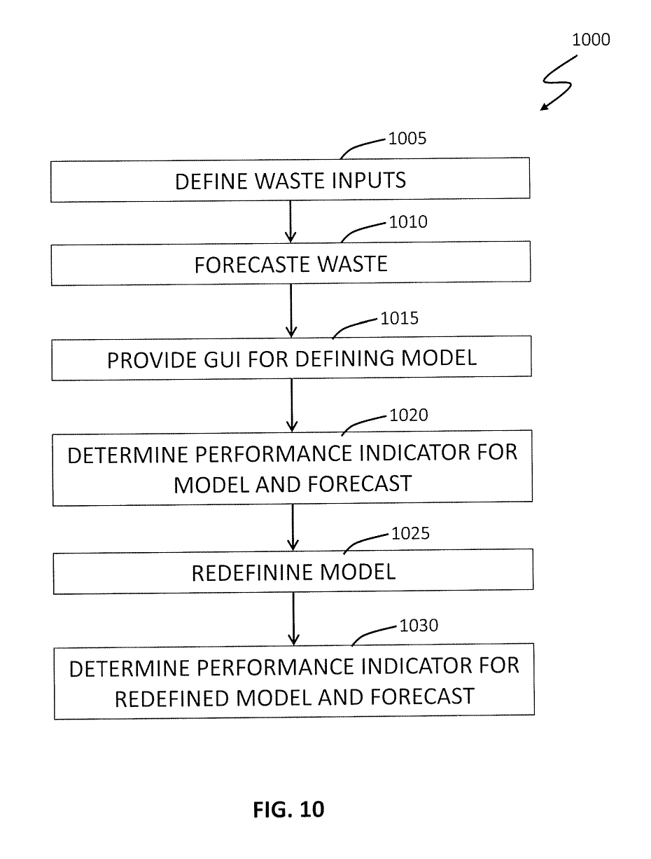

FIG. 10 illustrates a method 1000 of waste management simulation, according to an embodiment of the present invention.

At block 1005, a plurality of waste inputs is defined. The plurality of waste inputs can, for example, comprise tonnages for each of a plurality of collection services, as discussed above.

At block 1010, a forecast of the waste inputs is determined. The forecast can comprise an estimation of the waste inputs based upon a population growth trend and/or a waste trend. Furthermore, as discussed above, the forecast can include exceptional increases in waste input, for example due to a flood or other event.

At block 1015, a GUI is provided for interactively defining a waste management model. The model includes the plurality of waste inputs, a plurality of waste management facilities, and a plurality of waste streams connecting the waste inputs with the waste management facilities. As discussed above, the GUI can be configured to interactively define the waste management model by dragging and dropping.

At block 1020, at least one performance indicator of the model is determined according to the defined waste management model and a forecast of the waste inputs.

At block 1025, the model is redefined (modified), for example using the GUI. For example, the model can be redefined to include a new waste processing facility or the like.

At block 1030, the at least one performance indicator is determined according to the redefined waste management model and a forecast of the waste inputs. As such, the user is able to compare the waste management model and the redefined waste management model using the at least one performance indicator.

Certain embodiment of the present invention enable a city council to quickly and efficiently review the effect of introducing one more new facilities. In such case, the user can simply copy the model (see, for example, FIG. 6 above), make a series of changes, and compare one or more performance indicators before and after the change.

Similarly, certain embodiments of the present invention enable the city council to evaluate multiple forecasts. In such case, the user can copy an existing forecast, adjust it and observe the effects on the performance indicators.

According to certain embodiments, each combination of model, forecast and rules can be saved as a scenario. Multiple scenarios can the compared with each other, and performance indicators.

According to certain embodiments (not shown), a recycling market can be included in the model. In such case, the model can consider how much recyclable material is generated, and a value of this material.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A waste management simulation method including:
providing a graphical user interface for interactively defining a waste management model, wherein the model includes a plurality of waste inputs, a plurality of waste management facilities, and a plurality of waste streams connecting the waste inputs with the waste management facilities, and wherein the graphical user interface enables interactive definition of the waste streams; and
determining at least one performance indicator of the model according to the defined waste management model and a forecast of the waste inputs.

2. The waste management simulation method of claim 1, further including: defining a plurality of waste containers, wherein the waste inputs are defined at least partly according to the waste containers.

3. The waste management simulation method of claim 2, wherein the waste containers include a ‘general waste’ waste container, a ‘green waste’ waste container and ‘recycling’ waste container.

4. The waste management simulation method of claim 2, wherein the waste containers are dynamically defined.

5. The waste management simulation method of claim 2, further including: defining a composition of each of the waste containers, wherein the waste inputs are defined at least partly according to the composition of each of the waste containers.

6. The waste management simulation method of claim 1, wherein the forecast of the waste inputs is defined according to a population growth.

7. The waste management simulation method of claim 1, wherein exceptional increases in waste input can be provided, and wherein the forecast is adjusted according to the exceptional increases in waste input.

8. The waste management simulation method of claim 1, wherein the waste management facilities include recycling facilities and landfill facilities.

9. The waste management simulation method of claim 1, wherein the graphical user interface enables a user to define a waste stream between a waste input and a waste management facility by dragging an identifier of the waste input to an identifier of the waste management facility.

10. The waste management simulation method of claim 9, wherein the identifiers of the waste input and the waste management facility comprise images representing the waste input and the waste management facility.

11. The waste management simulation method of claim 1, further including:
determining the at least one performance indicator at a plurality of points on a timeline; and
presenting the at least one performance indicator according to the timeline.

12. The waste management simulation method of claim 11, wherein presenting the at least one performance indicator according to the timeline comprises automatically presenting changes to the at least one performance indicator according to a simulated playback of the timeline.

13. The waste management simulation method of claim 11, wherein the at least one performance indicator comprises a target.

14. The waste management simulation method of claim 13, wherein completion of the target can be visualised.

15. The waste management simulation method of claim 1, wherein the method further comprises providing an alert when a criterion is met.

16. The waste management simulation method of claim 1, wherein the GUI enables waste streams to connect waste management facilities with other waste management facilities.

17. The waste management simulation method of claim 1, wherein the GUI enables a user to select a first portion of an output to be sent to a first waste management facility, and a second portion of the output to be sent to a second waste management facility.

18. A waste management simulation system including:
a processor, and
a memory coupled to the processor, the memory including instruction code executable by the processor for:
providing a graphical user interface for interactively defining a waste management model, wherein the model includes a plurality of waste inputs, a plurality of waste management facilities, and a plurality of waste streams connecting the waste inputs with the waste management facilities, and wherein the graphical user interface enables interactive definition of the waste streams; and
determining at least one performance indicator of the model according to the defined waste management model and a forecast of the waste inputs.

19. The system of claim 18, further including a server, wherein the server includes the processor and the memory.

20. The system of claim 18, further including a data interface, for providing the graphical user interface to a user device by a communications network.
